(19) United States
(12) Patent Application Publication
(10) Pub. No.: US 2024/0213549 A1
(43) Pub. Date: Jun. 27, 2024

(54) RECHARGEABLE LITHIUM BATTERIES

(71) Applicant: SAMSUNG SDI CO., LTD., Yongin-si (KR)

(72) Inventors: Sanghyung KIM, Yongin-si (KR); Tae Hyon BAE, Yongin-si (KR); Harim LEE, Yongin-si (KR); Seunghyeon SON, Yongin-si (KR); Yunhee KIM, Yongin-si (KR); Arum YU, Yongin-si (KR)

(21) Appl. No.: 18/463,186

(22) Filed: Sep. 7, 2023

(30) Foreign Application Priority Data
Dec. 19, 2022 (KR) 10-2022-0178542

(51) Int. Cl. H01M 10/42; H01M 4/36; H01M 4/38; H01M 4/525; H01M 4/587; H01M 10/0525; H01M 10/0567; H01M 10/0569

(52) U.S. Cl. CPC H01M 10/4235; H01M 4/364; H01M 4/366; H01M 4/386; H01M 4/525; H01M 4/587; H01M 10/0525; H01M 10/0567; H01M 10/0569; H01M 2004/028

(57) ABSTRACT

A rechargeable lithium battery includes a positive electrode including a positive electrode active material including lithium cobalt-based oxide, a negative electrode including a carbon-based negative electrode active material and a silicon-based negative electrode active material, a separator between the positive electrode and the negative electrode, and an electrolyte solution. The silicon-based negative electrode active material is included in an amount of about 0.1 wt % to about 10 wt % based on the total amount of the carbon-based negative electrode active material and the silicon-based negative electrode active material. The electrolyte solution includes a non-aqueous organic solvent, a lithium salt, and an additive, and the additive includes a first compound that is a compound represented by Chemical Formula 1, CsPF₆, or a combination thereof, where R¹ and R² are each independently a fluoro group or a C1 to C4 fluoroalkyl group substituted with at least one fluoro group.

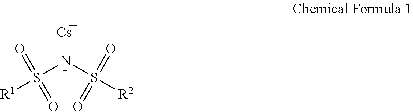

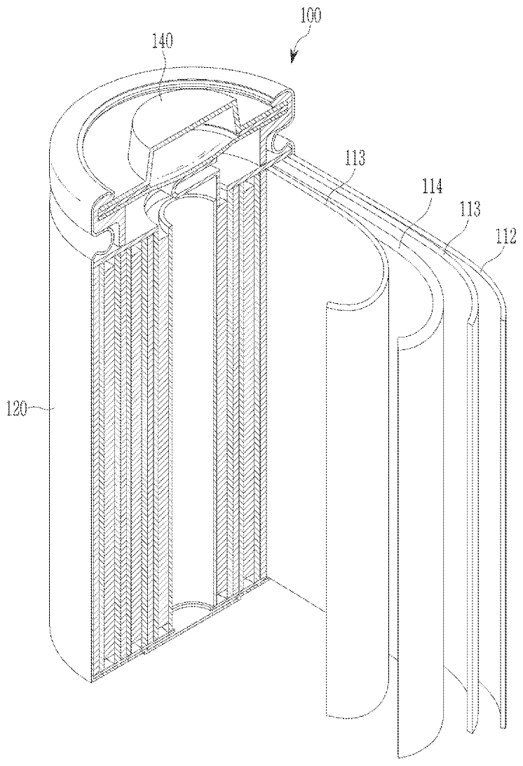

### CROSS-REFERENCE TO RELATED APPLICATION

This application claims priority to and the benefit of Korean Patent Application No. 10-2022-0178452, filed in the Korean Intellectual Property Office on Dec. 19, 2022, the entire content of which is incorporated herein by reference.

### BACKGROUND

### 1. Field

One or more embodiments of the present disclosure relate to a rechargeable lithium battery.

### 2. Description of the Related Art

A rechargeable lithium battery is widely utilized as a driving power source for mobile information terminals such as smart phones and laptops because it is easy to carry while implementing high energy density. Recently, a rechargeable lithium battery having (e.g., secured with) relatively high capacity, high energy density, and high safety has been actively studied for utilization as a power source for driving a hybrid vehicle or an electric vehicle, or a power source for power storage.

In a rechargeable lithium battery, an electrolyte solution plays an important role in delivering and transporting lithium ions. An electrolyte solution including an organic solvent and a lithium salt is typically (e.g., most commonly) utilized because it can exhibit extremely high ionic conductivity. In addition, the electrolyte solution also plays an important role in determining safety and performance of the rechargeable lithium battery.

Recently, as high-capacity, high-energy density batteries are required or desired, batteries need to be designed to be driven at a high voltage of 4.5 V or more as well as to increase energy density of electrodes. However, under severe and harsh operation conditions such as a high voltage or high-speed charging, a positive electrode is deteriorated, and lithium dendrites grow on surface of a negative electrode, which accelerate side reactions between the electrodes and the electrolyte solution; thus, there is a battery safety issue due to a decrease in a battery cycle-life, gas generation, and/or the like.

In order to address the battery safety issue, methods of protecting the electrodes through a surface treatment to suppress or reduce the side reactions of the electrodes with the electrolyte solution have been suggested and investigated. However, the methods have been reported to have problems that the surface treatment of the positive electrode exhibits no sufficient protection effect under high voltage driving conditions, while the surface treatment of the negative electrode deteriorates capacity. As a result, in the design of a high-capacity electrode drivable at a high voltage, development of an electrolyte solution capable of concurrently (e.g., simultaneously) improving the battery safety and performance is required or desired.

### SUMMARY

One or more aspects of embodiments of the present disclosure are directed toward a rechargeable lithium battery having concurrently (e.g., simultaneously) improved high capacity, high voltage, and cycle-life characteristics by designing an electrode capable of securing relatively high capacity, high voltage, and high-speed charging and applying an electrolyte solution having excellent or suitable oxidation resistance stability and forming a stable film in a high voltage environment thereto, decreasing both initial resistance and resistance increase rate at the high-temperature storage and thus effectively suppressing cycle-life degradation under a high voltage and/or rapid-charging condition.

In one or more embodiments of the present disclosure, a rechargeable lithium battery may include a positive electrode including a positive electrode active material including lithium cobalt-based oxide, a negative electrode including a carbon-based negative electrode active material and a silicon-based negative electrode active material, a separator between the positive electrode and the negative electrode, and an electrolyte solution, wherein the silicon-based negative electrode active material may be included in an amount of about 0.1 wt % to about 10 wt % based on the total amount of the carbon-based negative electrode active material and the silicon-based negative electrode active material, and the electrolyte solution may include a non-aqueous organic solvent, a lithium salt, and an additive, and the additive may include a first compound that is a compound represented by Chemical Formula 1, CsPF₆, or a combination thereof.

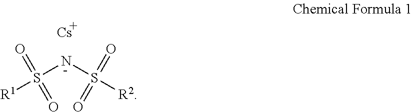

In Chemical Formula 1, R¹ and R² may each independently be a fluoro group, or a C1 to C4 fluoroalkyl group substituted with at least one fluoro group.

The rechargeable lithium battery according to one or more embodiments of the present disclosure suppresses or reduces elution of metal ions in the electrolyte solution while implementing high-capacity and high-voltage characteristics, effectively addresses resistance issues by reducing the initial resistance and a resistance increase rate during high-temperature storage, and improves cycle-life characteristics of the rechargeable lithium battery.

### BRIEF DESCRIPTION OF THE DRAWINGS

The accompanying drawing is included to provide a further understanding of the present disclosure, and is incorporated in and constitutes a part of this specification. The drawing illustrates example embodiments of the present disclosure and, together with the description, serve to explain principles of present disclosure. In the drawing:

The drawing is a schematic view illustrating a rechargeable lithium battery according to one or more embodiments of the present disclosure.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, example embodiments will be described in more detail so that those of ordinary skill in the art may easily implement them. However, the present disclosure may be embodied in many different forms and is not construed as limited to the example embodiments set forth herein.

The terminology utilized herein is utilized to describe embodiments only, and is not intended to limit the present disclosure. As utilized herein, the singular forms “a,” “an,” and “the” are intended to include the plural forms as well, unless the context clearly indicates otherwise. Further, the utilization of “may” when describing embodiments of the present disclosure may refer to “one or more embodiments of the present disclosure”.

As utilized herein, “combination thereof” may refer to a mixture, laminate, composite, copolymer, alloy, blend, reaction product, and/or the like of constituents.

Herein, it should be understood that terms such as “comprise(s),” “include(s),” or “have/has” are intended to designate the presence of an embodied feature, number, step, element, or a combination thereof, but it does not preclude the possibility of the presence or addition of one or more other features, numbers, steps, elements, or a combination thereof.

In the drawings, the thickness of layers, films, panels, regions, etc., may be exaggerated for clarity and like reference numerals designate like elements throughout the present disclosure, and duplicative descriptions thereof may not be provided for conciseness. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In some embodiments, “layer” utilized herein may include not only a shape formed on the whole surface when viewed from a plan view, but also a shape formed on a partial surface.

In some embodiments, an average particle diameter may be measured by a method well suitable to those skilled in the art, for example, may be measured by a particle size analyzer, or may be measured by an optical microscope image such as a transmission electron micrograph or a scanning electron micrograph. In some embodiments, an average particle diameter value may be obtained by measuring utilizing a dynamic light scattering method, performing data analysis, counting the number of particles for each particle size range, and calculating from the data. Unless otherwise defined, an average particle diameter may refer to the diameter (D50) of particles having a cumulative volume of 50 volume % in a particle size distribution. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. Also, in the present disclosure, when particles are spherical, “diameter” indicates a particle diameter or an average particle diameter, and when the particles are non-spherical, the “diameter” indicates a major axis length or an average major axis length.

Herein, “or” is not to be construed as an exclusive meaning, for example, “A or B” is construed to include A, B, A+B, and/or the like. Further, as used herein, the term “and/or” includes any and all combinations of one or more of the associated listed items. The “/” utilized herein may be interpreted as “and” or as “or” depending on the situation. Expressions such as “at least one of,” “one of,” and “selected from,” when preceding a list of elements, modify the entire list of elements and do not modify the individual elements of the list. For example, “at least one of a, b, or c”, “at least one of a, b, and/or c”, “at least one selected from a, b, and c”, “at least one selected from among a to c”, etc. may indicate only a, only b, only c, both (e.g., simultaneously) a and b, both (e.g., simultaneously) a and c, both (e.g., simultaneously) b and c, all of a, b, and c, or variations thereof.

As utilized herein, unless otherwise defined, “substituted” may refer to replacement of at least one hydrogen in a substituent or compound by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In some embodiments, “substituted” may refer to replacement of at least one hydrogen in a substituent or compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, “substituted” may refer to replacement of at least one hydrogen in a substituent or compound by deuterium, a halogen, a C1 to C20 alkyl group, a C6 to C30 aryl group, a C1 to C10 fluoroalkyl group, or a cyano group. In some embodiments, “substituted” may refer to replacement of at least one hydrogen in a substituent or compound by deuterium, a halogen, a C1 to C5 alkyl group, a C6 to C18 aryl group, a C1 to C5 fluoroalkyl group, or a cyano group. For example, “substituted” may refer to replacement of at least one hydrogen in a substituent or compound by deuterium, a cyano group, a halogen, a methyl group, an ethyl group, a propyl group, a butyl group, a phenyl group, a biphenyl group, a terphenyl group, a trifluoromethyl group, or a naphthyl group.

Expressions such as C1 to C30 refer to that the number of carbon atoms is 1 to 30.

### Rechargeable Lithium Battery

In one or more embodiments of the present disclosure, a rechargeable lithium battery may include a positive electrode including a positive electrode active material including lithium cobalt-based oxide, a negative electrode including a carbon-based negative electrode active material and a silicon-based negative electrode active material, a separator between the positive electrode and the negative electrode, and an electrolyte solution, wherein the silicon-based negative electrode active material may be included in an amount of about 0.1 wt % to about 10 wt % based on the total amount of the carbon-based negative electrode active material and the silicon-based negative electrode active material, and the electrolyte solution may include a non-aqueous organic solvent, a lithium salt, and an additive, where the additive may include a first compound that will be described later.

In the rechargeable lithium battery of one or more embodiments, the positive electrode and the negative electrode may be referred to electrodes capable of implementing high capacity, high voltage, and rapid charging characteristics. By incorporating an electrolyte solution with excellent or suitable voltage resistance and oxidation resistance stability, which may maximize or enhance the performance of these electrodes, the initial resistance and high-temperature performance in a high-capacity battery system are improved, and the deterioration of cycle-life due to rapid charging is suppressed, thereby improving the overall performance of the battery. In the present disclosure, the rechargeable lithium battery may also be referred to as a 4.5 V class high voltage battery.

The drawing is a schematic view illustrating a rechargeable lithium battery according to one or more embodiments of the present disclosure. Referring to the drawing, a rechargeable lithium battery 100 may include a battery cell including a positive electrode 114, a negative electrode 112 facing the positive electrode 114, a separator 113 between the positive electrode 114 and the negative electrode 112, and an electrolyte solution impregnating the positive electrode 114, the negative electrode 112, and the separator 113, a battery case 120 containing the battery cell, and a sealing member 140 sealing the battery case 120.

### Positive Electrode

The positive electrode 114 may include a positive electrode current collector and a positive electrode active material layer on the positive electrode current collector. The positive electrode active material layer may include a positive electrode active material and may optionally include a binder and/or a conductive material.

### Positive Electrode Active Material

The positive electrode active material according to one or more embodiments may include a lithium cobalt-based oxide. The lithium cobalt-based oxide may refer to an oxide including lithium and cobalt, and optionally further including other elements in addition to lithium and cobalt. The positive electrode active material including lithium cobalt-based oxide may realize high capacity and high initial charge/discharge efficiency, may be suitable for high voltage and high-speed charging, and may exhibit excellent or suitable resistance characteristics, high-temperature performance, and cycle-life characteristics when utilized together with an electrolyte solution of one or more embodiments to be described later.

The lithium cobalt-based oxide may be represented by Chemical Formula 3.

Liₐ₁Coₓ₁M¹_{y1}O_{2-b1}X_{b1}. Chemical Formula 3

In Chemical Formula 3, 0.9≤a1≤1.8, 0.7≤x1≤1, 0≤y1≤0.3, 0.9≤x1+y1≤1.1, 0≤b1≤0.1, M¹ may be at least one element selected from aluminum (Al), boron (B), barium (Ba), calcium (Ca), cerium (Ce), chromium (Cr), copper (Cu), iron (Fe), magnesium (Mg), manganese (Mn), molybdenum (Mo), nickel (Ni), selenium (Se), silicon (Si), tin (Sn), strontium (Sr), titanium (Ti), vanadium (V), tungsten (W), yttrium (Y), zinc (Zn), and zirconium (Zr), and X may be at least one element selected from fluorine (F), phosphorus (P), and sulfur (S).

In some embodiments, in Chemical Formula 3, x1 may be 0.8≤x1≤1, 0.9≤x1≤1, or 0.95≤x1≤1. For example, in some embodiments, M¹ may be at least one element selected from Al, Ca, Ce, Cr, Cu, Fe, Mg, Mo, Se, Sr, Ti, V, W, Y, Zn, and Zr. M¹ may increase structural stability of the lithium cobalt-based oxide at high voltage, and play a role of suppressing structural change or collapse due to movement of lithium ions.

The positive electrode active material may be in a particle form or in a form of a plurality of particles including lithium cobalt-based oxide, and may be, for example, in a form of secondary particles in which (e.g., in each of which) a plurality of primary particles made of lithium cobalt-based oxide are aggregated. The secondary particles may have an average particle diameter (D50) of about 1 μm to about 30 μm. Herein, an average particle diameter (D50) may be measured by a particle size analyzer and may refer to a diameter of particles whose cumulative volume is 50 volume % in a particle size distribution.

For example, in one or more embodiments, the positive electrode active material may have a bimodal form that large particles and small particles are mixed. The positive electrode active material may include a first positive electrode active material including lithium cobalt-based oxide in a particle form having an average particle diameter (D50) of about 9 μm to about 25 μm and a second positive electrode active material that is particles including lithium cobalt-based oxide and having an average particle diameter (D50) of about 1 μm to about 8 μm. In these embodiments, the first positive electrode active material may be included in an amount of about 60 wt % to about 90 wt %, and the second positive electrode active material may be included in an amount of about 10 wt % to about 40 wt % based on the total amount of first positive electrode active material and the second positive electrode active material. A positive electrode including such a positive electrode active material is advantageous or suitable in realizing high capacity and high energy density.

### Binder

The binder serves to attach the positive electrode active material particles to each other and to attach the positive electrode active material to the positive electrode current collector. Non-limiting examples of the binder may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but embodiments of the present disclosure are not limited thereto.

The content (e.g., amount) of the binder in the positive electrode active material layer may be approximately (about) 0.1 wt % to (about) 5 wt % based on the total weight of the positive electrode active material layer.

### Conductive Material

The conductive material may be included to provide electrodes conductivity, and any electrically conductive material may be utilized as a conductive material unless it causes a chemical change. Non-limiting examples of the conductive material may include a carbon-based material such as natural graphite, artificial graphite, carbon black, acetylene black, ketjen black, a carbon fiber, carbon nanofiber, carbon nanotube, and/or the like; a metal-based material of a metal powder or a metal fiber including copper, nickel, aluminum, silver, and/or the like; a conductive polymer such as a polyphenylene derivative; or a mixture thereof.

The content (e.g., amount) of the conductive material in the positive electrode active material layer may be about 1 wt % to about 5 wt % based on the total weight of the positive electrode active material layer.

In one or more embodiments, an aluminum foil may be utilized as the positive electrode current collector, but embodiments of the present disclosure are not limited thereto.

### Negative Electrode

The negative electrode 112 may include a negative electrode current collector and a negative electrode active material layer on the negative electrode current collector. The negative electrode active material layer may include a negative electrode active material, and may optionally include a binder and/or a conductive material.

### Negative Electrode Active Material

The negative electrode active material according to one or more embodiments of the present disclosure may include a carbon-based negative electrode active material and a silicon-based negative electrode active material. In one or more embodiments, the silicon-based negative electrode active material may be included in an amount of about 0.1 wt % to about 10 wt %, for example about 1 wt % to about 7 wt %, about 2 wt % to about 5 wt %, or about 2.5 wt % to about 5 wt % based on the total amount of the carbon-based negative electrode active material and the silicon-based negative electrode active material.

As such, high capacity may be realized, it is advantageous or suitable for high voltage and high-speed charging, and excellent or suitable resistance characteristics, high-temperature performance, and cycle-life characteristics may also be exhibited when utilized with the electrolyte solution of one or more embodiments of the present disclosure. For example, in contrast, when the content (e.g., amount) of the silicon-based negative electrode active material exceeds 5 wt %, even when the electrolyte solution of the present disclosure is applied, the initial resistance of the battery may increase or the resistance increase rate during high-temperature storage may increase excessively.

The carbon-based negative electrode active material may be a material capable of reversibly intercalating/deintercalating lithium ions, and may be crystalline carbon, amorphous carbon, or a combination thereof. The crystalline carbon may be, for example, irregular-shaped, plate-like, flake-like, substantially spherical, or fiber-shaped graphite, and the graphite may be natural graphite or artificial graphite. The amorphous carbon may be, for example, soft carbon, hard carbon, a mesophase pitch carbonized product, or calcined coke. In some embodiments, the carbon-based negative electrode active material may be, for example, crystalline carbon.

The silicon-based negative electrode active material may include, for example, silicon, a silicon-carbon composite, SiOₓ (0<x<2), a Si-Q alloy, or a combination thereof. In the Si-Q alloy, Q may be at least one element selected from an alkali metal, an alkaline earth metal, a Group 13 element, a Group 14 element, a Group 15 element, a Group 16 element, a transition metal, and a rare earth element, except Si. In one or more embodiments, the Q may be at least one selected from, for example, magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (AI), gallium (Ga), tin (Sn), indium (In), thallium (TI), germanium (Ge), phosphorus (P), arsenic (As), antimony (Sb), bismuth (Bi), sulfur (S), selenium (Se), tellurium (Te), and polonium (Po).

In one or more embodiments, the silicon-based negative electrode active material may include silicon-carbon composite particles. An average particle diameter (D50) of the silicon-carbon composite particles may be, for example, about 0.5 μm to about 20 μm. Likewise, an average particle diameter (D50) may be measured by a particle size analyzer and may refer to a diameter of particles whose cumulative volume is about 50 volume % in a particle size distribution. In one or more embodiments, the silicon may be included in an amount of about 10 wt % to about 60 wt % and the carbon may be included in an amount of about 40 wt % to about 90 wt % based on 100 wt % of the silicon-carbon composite particles.

In one or more embodiments, the silicon-carbon composite particle may include, for example, a core containing silicon particles and a carbon coating layer on a surface of the core. An average particle diameter (D50) of the silicon particles in the core may be about 10 nm to about 1 μm, or about 10 nm to about 200 nm. The silicon particle may exist alone, in the form of a silicon alloy, or in an oxidized form. The oxidized form of silicon may be represented as SiOₓ (0<x<2). In one or more embodiments, the carbon coating layer may have a thickness of about 5 nm to about 100 nm.

For example, in some embodiments, the silicon-carbon composite particle may include a core including silicon particles and crystalline carbon, and a carbon coating layer disposed on a surface of the core and including amorphous carbon. For example, in one or more embodiments, in the silicon-carbon composite particle, the amorphous carbon may not exist in the core but only in the carbon coating layer.

The crystalline carbon may be artificial graphite, natural graphite, or a combination thereof, and the amorphous carbon may be coal-based pitch, mesophase pitch, petroleum-based pitch, coal-based oil, petroleum-based heavy oil, or a polymer resin (phenol resin, furan resin, polyimide resin, etc.). In one or more embodiments, a content (e.g., amount) of the crystalline carbon may be about 10 wt % to about 70 wt %, and a content (e.g., amount) of the amorphous carbon may be about 20 wt % to about 40 wt % based on 100 wt % of the silicon-carbon composite particle.

In one or more embodiments, in the silicon-carbon composite particle, the core may include a void in the central portion of the silicon-carbon composite particle. The radius of the void may be about 30% to about 50% by length of the radius of the silicon-carbon composite particle.

The aforementioned silicon-carbon composite particle effectively may suppress or reduce issues such as volume expansion, structural collapse, or particle crushing due to charging and discharging to prevent or reduce the disconnection of conductive paths, may realize high capacity and high efficiency, and may be utilized under high-voltage and/or high-speed charging condition.

In one or more embodiments, the negative electrode active material may further include lithium metal, a lithium metal alloy, a tin-based negative electrode active material, a transition metal oxide, or a combination thereof, in addition to the aforementioned carbon-based negative electrode active material and silicon-based negative electrode active material.

The lithium metal alloy may be an alloy of at least one element selected from Na, K, Rb, Cs, Fr, Be, Mg, Ca, Sr, Si, Sb, Pb, In, Zn, Ba, Ra, Ge, Al and Sn, and lithium.

The tin-based negative electrode active material may be, for example, Sn, SnO₂, a Sn—R alloy, or a combination thereof. In the Sn—R alloy, R may be at least one element selected from an alkali metal, an alkaline earth metal, a Group 13 element, a Group 14 element, a Group 15 element, a Group 16 element, a transition metal, and a rare earth element, except tin. In one or more embodiments, the R may be at least one selected from, for example, Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, and Po.

### Binder

The binder serves to adhere the negative electrode active material particles to each other and also to adhere the negative electrode active material to the negative electrode current collector. The binder may be a water-insoluble binder, a water-soluble binder, or a combination thereof.

Non-limiting examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber binder or a polymer resin binder. The rubber binder may be at least one selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be at least one selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

In some embodiments, when a water-soluble binder is utilized as the binder for the negative electrode, a cellulose-based compound capable of imparting viscosity may be further included as a kind of thickener. As the cellulose-based compound, one or more of carboxymethyl cellulose, hydroxypropylmethyl cellulose, methyl cellulose, or alkali metal salts thereof may be mixed and utilized. The alkali metal may be Na, K, or Li. The amount of the thickener utilized may be about 0.1 parts by weight to about 3 parts by weight based on 100 parts by weight of the negative electrode active material.

A content (e.g., amount) of the binder may be about 0.1 wt % to about 5 wt % based on 100 wt % of the negative electrode active material layer.

### Conductive Material

The conductive material may be (e.g., is) included to provide electrodes conductivity and any electrically conductive material may be utilized as a conductive material unless it causes a chemical change. Non-limiting examples of the conductive material may include a carbon-based material such as natural graphite, artificial graphite, carbon black, acetylene black, ketjen black, a carbon fiber, a carbon nanofiber, a carbon nanotube, and/or the like; a metal-based material of a metal powder or a metal fiber including copper, nickel, aluminum, silver, and/or the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

### Electrolyte Solution

The electrolyte solution according to one or more embodiment of the present disclosure may include a non-aqueous organic solvent, a lithium salt, and an additive, and the additive may include a first compound that is a compound represented by Chemical Formula 1, CsPF₆, or a combination thereof. The electrolyte solution has excellent or suitable voltage resistance and oxidation resistance stability, and when utilized with the aforementioned positive electrode and the negative electrode, a stable film may be formed on an interface between the electrode and the electrolyte solution even in a high voltage environment, and the phenomenon of elution of metal ions into the electrolyte solution may be effectively suppressed or reduced, resulting in lowering an initial resistance and improving the high-temperature characteristics of a rechargeable lithium battery having a high-capacity and high-voltage design.

### Additive(s)

The compound represented by Chemical Formula 1 may be referred to as a cesium sulfonylimide salt or a cesium fluorinated sulfonylimide salt.

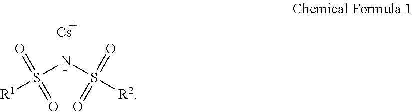

In Chemical Formula 1, R¹ and R² may each independently be a fluoro group, or a C1 to C4 fluoroalkyl group substituted with at least one fluoro group.

The first compound that is the compound represented by Chemical Formula 1, CsPF₆, or a combination thereof may be decomposed in the electrolyte solution under high voltage conditions to form a stable film on the surface of the electrode (e.g., the negative electrode), and may effectively control the elution of lithium ions from the electrode to prevent or reduce electrode decomposition. For example, the first compound may be reduced and decomposed before a decomposition of non-aqueous organic solvents such as carbonate-based solvents to form a solid-electrolyte-interface (SEI) film at an interface between the negative electrode and the electrolyte solution, thereby preventing or reducing decomposition of the electrolyte solution and electrode, and suppressing an increase in battery internal resistance due to gas generation. It is understood that the SEI film is partially decomposed through a reduction reaction during charging and discharging and moves to the surface of the positive electrode to form a film at an interface between the positive electrode and the electrolyte solution through an oxidation reaction, thereby preventing or reducing the decomposition of the positive electrode and the oxidation reaction of the electrolyte solution.

For example, in one or more embodiments, in Chemical Formula 1, R¹ and R² may each independently be a fluoro group or a C1 to C4 fluoroalkyl group substituted with at least two fluoro groups. In some embodiments, R¹ and R² may each independently be a fluoro group or a C1 to C4 fluoroalkyl group substituted with at least three fluoro groups. For example, in some embodiments, R¹ and R² may each independently be a fluoro group or a C1 to C3 fluoroalkyl group substituted with at least three fluoro groups. In some embodiments, R¹ and R² may each independently be a fluoro group or a C1 to C2 fluoroalkyl group substituted with at least three fluoro groups.

For example, in one or more embodiments, the compound represented by Chemical Formula 1 may be represented by Chemical Formula 1-1 or Chemical Formula 1-2.

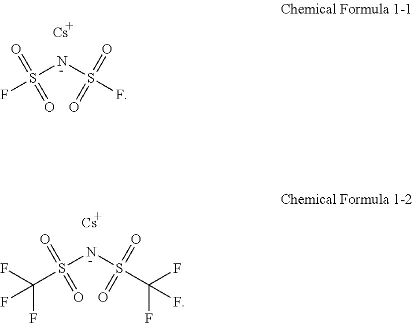

In one or more embodiments, the first compound may be included in an amount of about 0.01 parts by weight to about 5.0 parts by weight, for example about 0.05 parts by weight to about 4.0 parts by weight, about 0.1 parts by weight to about 3.0 parts by weight, about 0.1 parts by weight to about 4.0 parts by weight, about 0.1 parts by weight to about 1.0 part by weight, or about 0.1 parts by weight to about 0.7 parts by weight based on 100 parts by weight of the total amount of the non-aqueous organic solvent and the lithium salt. When the first compound is included in the above range, a voltage resistance and oxidation resistance stability of the electrolyte solution is improved without adversely affecting the overall performance of the battery, a resistance increase problem of the battery designed for high capacity and high voltage is effectively addressed or resolved, and high-temperature performance of the battery is improved. For example, when the content (e.g., amount) of the compound represented by Chemical Formula 1 is excessive, a resistance increase rate in a battery during high-temperature storage may increase.

In one or more embodiments, the additive(s) may further include a second compound represented by Chemical Formula 2, in addition to the aforementioned first compound. The second compound represented by Chemical Formula 2 may be referred to as a cesium fluorinated sulfonylimide salt, and has a different structural formula from Chemical Formula 1. The second compound represented by Chemical Formula 2 is decomposed in the electrolyte solution during battery operation to form a stable film on the surface of the electrode (e.g., negative electrode), and may effectively control the problem of elution of lithium ions from the electrode. When the additive(s) further include the second compound represented by Chemical Formula 2, the voltage resistance and oxidation resistance stability of the electrolyte solution may be further improved in a high-capacity, high-voltage battery.

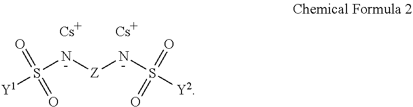

In Chemical Formula 2, Z may be C(═O) or S(═O)₂, and Y¹ and Y² may each independently be a fluoro group or a C1 to C5 fluoroalkyl group substituted with at least one fluoro group.

In Y¹ and Y², the C1 to C5 fluoroalkyl group substituted with at least one fluoro group may be, for example, a C1 to C5 fluoroalkyl group substituted with at least two fluoro groups, or a C1 to C5 fluoroalkyl group substituted with at least three fluoro groups, and the C1 to C5 fluoroalkyl group may be, for example, a C1 to C4 fluoroalkyl group, a C1 to C3 fluoroalkyl group, or a C1 to C2 fluoroalkyl group.

In one or more embodiments, the second compound represented by Chemical Formula 2 may be, for example, represented by any one selected from among Chemical Formulas 2-1 to 2-8.

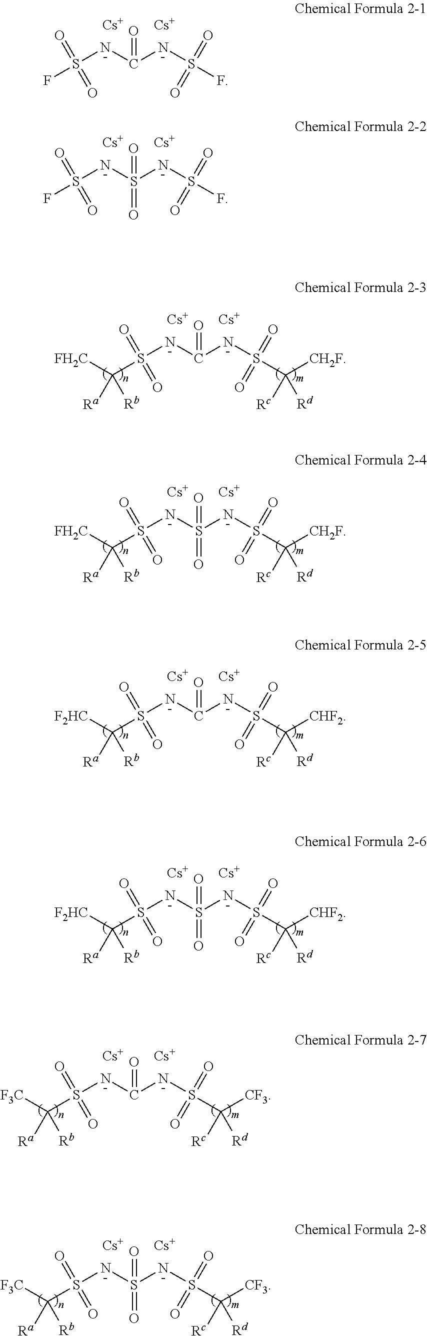

In Chemical Formulas 2-3 to 2-8, Ra, R^{b}, R^{C}, and R^{d} may each independently be hydrogen or a fluoro group, and n and m may each independently be an integer of 0 to 4. For example, in some embodiments, n and m may each independently be 0, 1, or 2.

In one or more embodiments, the second compound represented by Chemical Formula 2 may be included in an amount of about 0.01 parts by weight to about 5 parts by weight, for example about 0.05 parts by weight to about 4.0 parts by weight, about 0.1 parts by weight to about 3.0 parts by weight, about 0.1 parts by weight to about 4.0 parts by weight, about 0.1 parts by weight to about 1.0 part by weight, or about 0.1 parts by weight to about 0.7 parts by weight based on 100 parts by weight of the total amount of the non-aqueous organic solvent and the lithium salt. When the compound represented by Formula 2 is included in the above range, the voltage resistance and oxidation resistance stability of the electrolyte solution may be improved without adversely affecting the overall performance of the battery, and the high-temperature performance of a battery designed for high capacity and high voltage may be improved.

In one or more embodiments, the electrolyte solution may further include other additive(s) in addition to the aforementioned additive(s), and the other additives may include vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluoro biphenyl (2-FBP), or a combination thereof.

When the electrolyte solution further includes such other additive(s), high-temperature storage characteristics may be improved, for example, gases generated from the positive electrode and the negative electrode during high-temperature storage may be effectively controlled or reduced.

In one or more embodiments, the other additive(s) may be included in an amount of about 0.1 part by weight to about 20 parts by weight, for example, about 0.2 parts by weight to about 15 parts by weight, or about 0.5 parts by weight to about 10 parts by weight based on 100 parts by weight of the total amount of the non-aqueous organic solvent and the lithium salt. When the other additives are included within the above ranges, a rechargeable lithium battery having improved high-temperature storage characteristics such as effectively controlling gas generated from an electrode without adversely affecting the overall performance of the battery may be implemented.

### Non-Aqueous Organic Solvent

The non-aqueous organic solvent serves as a medium through which ions involved in the electrochemical reaction of the battery may be transferred. As the non-aqueous organic solvent, a carbonate-based solvent, an ester-based solvent, an ether-based solvent, a ketone-based solvent, an alcohol-based solvent, an aprotic solvent, or a combination thereof may be utilized.

In one or more embodiments, the non-aqueous organic solvent may include a carbonate-based solvent and an ester-based solvent. For example, the non-aqueous organic solvent may include a carbonate-based solvent and a C1 to C8 alkyl propionate. In these embodiments, the electrolyte solution may realize excellent or suitable voltage resistance and oxidation resistance stability, and may be suitable for application to the aforementioned high-capacity, high-voltage electrode design.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or a combination thereof.

The ester-based solvent may include, for example, methyl acetate, ethyl acetate, n-propyl acetate, dimethyl acetate, methyl propionate, ethyl propionate, propyl propionate, butyl propionate, γ-butyrolactone, decanolide, valerolactone, mevalonolactone, caprolactone, or a combination thereof.

The ether-based solvent may include, for example, dibutyl ether, tetraglyme, diglyme, dimethoxyethane, 2-methyltetrahydrofuran, tetrahydrofuran, or a combination thereof.

The ketone-based solvent may be, for example, cyclohexanone, and the alcohol-based solvent may include, for example, ethyl alcohol, isopropyl alcohol, or a combination thereof. The aprotic solvent may include, for example nitriles such as R—CN (wherein, R is a C2 to C20 linear, branched, or cyclic hydrocarbon group and may include a double bond, an aromatic ring, or an ether bond), and/or the like, amides such as dimethyl formamide, and/or the like, dioxolanes such as 1,3-dioxolane, and/or the like, or a combination thereof.

The non-aqueous organic solvent may be utilized alone or in a mixture. When the non-aqueous organic solvent is utilized in a mixture, a mixture ratio may be controlled or selected in accordance with a desirable battery performance.

According to one or more embodiments, when the non-aqueous organic solvent includes the carbonate-based solvent and the ester-based solvent, about 10 volume % to about 60 volume % of the carbonate-based solvent and about 40 volume % to about 90 volume % of the ester-based solvent based on 100 volume % of the carbonate-based solvent and the ester-based solvent may be included. In these embodiments, the voltage resistance and oxidation resistance stability of the electrolyte solution may be improved in a high-capacity high-voltage battery system.

In some embodiments, the carbonate-based solvent may include a cyclic carbonate and a chain carbonate. When the cyclic carbonate and the chain carbonate are mixed in a volume ratio of about 1:1 to about 1:9, the overall performance of the electrolyte solution may be improved.

In one or more embodiments, the non-aqueous organic solvent may further include an aromatic hydrocarbon-based organic solvent in addition to the carbonate-based solvent. The carbonate-based solvent and the aromatic hydrocarbon-based organic solvent may be mixed in a volume ratio of about 1:1 to about 30:1.

The aromatic hydrocarbon-based solvent may be, for example, a compound represented by Chemical Formula I.

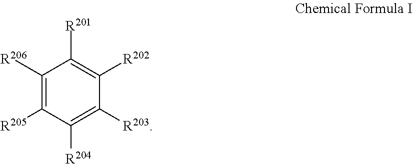

In Chemical Formula I, R²⁰¹ to R²⁰⁶ may each independently be the same or different and may each independently be selected from hydrogen, a halogen group, a C1 to C10 alkyl group, and a C1 to C10 haloalkyl group.

In one or more embodiments, the aromatic hydrocarbon-based solvent may include, for example, benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

In one or more embodiments, the electrolyte solution may further include vinylene carbonate or an ethylene carbonate-based compound of Chemical Formula II as a cycle-life improving additive.

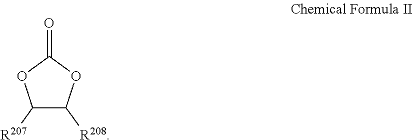

In Chemical Formula II, R²⁰⁷ and R²⁰⁸ may each independently be the same or different, and may each independently be selected from hydrogen, a halogen, a cyano group, a nitro group, and fluorinated C1 to C5 alkyl group, provided that at least one of R²⁰⁷ or R²⁰⁸ is selected from a halogen group, a cyano group, a nitro group, and a fluorinated C1 to C5 alkyl group, and both (e.g., simultaneously) of R²⁰⁷ and R²⁰⁸ are not concurrently (e.g., simultaneously) hydrogen.

Non-limiting examples of the ethylene carbonate-based compound may be difluoroethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be utilized within an appropriate or suitable range.

### Lithium Salt

The lithium salt dissolved in the non-aqueous organic solvent supplies lithium ions in a battery (e.g., rechargeable lithium battery), enables a basic operation of a rechargeable lithium battery, and improves transportation of lithium ions between positive and negative electrodes of the rechargeable lithium battery.

Non-limiting examples of the lithium salt may include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein x and y are natural numbers, for example, an integer in a range of 1 to 20), lithium difluoro(bisoxalato) phosphate, LiCl, Lil, LiB(C₂O₄)₂ (lithium bis(oxalato) borate, LiBOB), and lithium difluoro(oxalato)borate (LiDFOB).

The lithium salt may be utilized in a concentration in a range of about 0.1 M to about 2.0 M. When the lithium salt is included in the above concentration range, the electrolyte solution may have excellent or suitable performance and lithium ion mobility due to optimal or suitable conductivity and viscosity of the electrolyte solution.

### Separator

The separator 113 separates the positive electrode 114 and the negative electrode 112 and provides a transporting passage for lithium ions and may be any generally-utilized separator in a lithium ion battery. The separator may have low resistance to ion transport and excellent or suitable impregnation for the electrolyte solution. For example, in one or more embodiments, the separator may include a glass fiber, polyester, polyethylene, polypropylene, polytetrafluoroethylene, or a combination thereof and may have a form of a non-woven fabric or a woven fabric. For example, in some embodiments, in a lithium ion battery (e.g., rechargeable lithium battery), a polyolefin-based polymer separator such as polyethylene and polypropylene separator may be mainly utilized. In order to ensure the heat resistance or mechanical strength, a coated separator including a ceramic component or a polymer material may be utilized. In some embodiments, it may have a mono-layered or multi-layered structure.

Rechargeable lithium batteries may be classified as lithium ion batteries, lithium ion polymer batteries, or lithium polymer batteries according to the presence of a separator and the type or kind of electrolyte solution utilized therein. The rechargeable lithium batteries may have a variety of shapes and sizes, and non-limiting shape examples thereof may include cylindrical, prismatic, coin, and/or pouch-type or kind batteries, and non-limiting size examples thereof may be thin film batteries and/or may be rather bulky in size batteries. Structures and manufacturing methods for these batteries pertaining to the present disclosure are well suitable in the art.

The rechargeable lithium battery according to one or more embodiments may be utilized in an electric vehicle (EV), a hybrid electric vehicle such as a plug-in hybrid electric vehicle (PHEV), and/or portable electronic device because it implements a high capacity and has excellent or suitable storage stability, cycle-life characteristics, and high rate characteristics at high temperatures.

Hereinafter, examples of the present disclosure and comparative examples are described in more detail. However, the examples are for the purpose of illustration and are not to be construed as limiting the present disclosure.

### Example 1

### (1) Manufacture of Positive Electrode

A first positive electrode active material (LiCo_{0.974}Al_{0.0210}Mg_{0.005}O₂) (in a particle form) having an average particle diameter (D50) of about 20 μm and a second positive electrode active material (LiCo_{0.9823}Al_{0.0127}Mg_{0.005}O₂) (in a particle form) having an average particle diameter (D50) of about 4 μm were mixed in a weight ratio of 8:2 to prepare a positive electrode active material.

95 wt % of the prepared positive electrode active material, 3 wt % of a polyvinylidene fluoride binder, and 2 wt % of a ketjen black conductive material were mixed in an N-methyl pyrrolidone solvent to prepare positive electrode active material slurry. The positive electrode active material slurry was coated on an aluminum current collector, dried, and then compressed to prepare a positive electrode.

### (2) Manufacture of Negative Electrode

95 wt % of graphite was mixed with 5 wt % of a silicon-carbon composite particles (in a particle form) to prepare a negative electrode active material. A silicon-carbon composite particle included a core including artificial graphite and a silicon particle and a carbon coating layer of coal pitch formed on the surface of the core.

The prepared negative electrode active material, a styrene-butadiene rubber binder, and carboxymethylcellulose were mixed in a weight ratio of 98:1:1, respectively, and dispersed in distilled water to prepare negative electrode active material slurry. The negative electrode active material slurry was coated on a copper current collector, dried, and then compressed to manufacture a negative electrode.

### (3) Preparation of Electrolyte Solution

Ethylene carbonate (EC), propylene carbonate (PC), ethyl propionate (EP), and propyl propionate (PP) were mixed in a volume ratio of 10:15:30:45 to prepare a non-aqueous organic solvent. LiPF₆ lithium salt was dissolved at a concentration of 1.3 M to prepare a basic electrolyte solution. 0.25 parts by weight of the compound represented by Chemical Formula 1-1 was added to 100 parts by weight of the basic electrolyte solution to prepare an electrolyte solution.

### (4) Manufacture of Rechargeable Lithium Battery Cell

A polyethylene polypropylene multilayer separator was disposed between the prepared positive electrode and negative electrode, the resultant was inserted into a pouch cell, and then the prepared electrolyte solution was injected to manufacture a 4.5 V pouch-type or kind full cell.

### Examples 2 to 8 and Comparative Examples 1 to 7

Each rechargeable lithium battery cell was manufactured in substantially the same manner as in Example 1 except that a content (e.g., amount) of the silicon-carbon composite particles in the negative electrode and a content (e.g., amount) of the compound represented by Chemical Formula 1-1 in the electrolyte solution were changed as shown in Table 1.

### Evaluation Example 1: Evaluation of High-Temperature Storage Characteristics

The rechargeable lithium battery cells of Examples 1 to 8 and Comparative Examples 1 to 7 were each charged from 3.0 V to an upper limit of 4.5 V under a constant current condition of 1.5 C, paused for 10 minutes, and discharged to 3.0 V under a condition of 1.0 C at 25° C. to perform initial charge and discharge. Subsequently, ΔV/ΔI (voltage change/current change) of each battery cell, which is initial DC resistance (DC-IR), was measured, and the results are shown in Table 1. Then, the battery cells were each brought to a full-charge state (state of charge (SOC) 100%), stored at 60° C. for 30 days and then, measured again with respect to DC-IR, and the results are shown in Table 1. In addition, a ratio of DC-IR after stored at 60° C. for 30 days to the initial DC-IR was calculated, and the results are shown as a resistance increase rate in Table 1.

TABLE 1

| | | | Electrolyte | | | |
|---|---|---|---|---|---|---|
| | Negative electrode | | solution | | | |
| | | Silicon- | Chemical | | DC-IR after | |
| | | carbon | Formula | | storage at | Resistance |
| | | composite | 1-1 | Initial | 60° C. for | increase |
| | Graphite | particles | parts by | DC-IR | 30 days | rate |
| | wt % | wt % | weight | mΩ | mΩ | % |
| Comparative | 100 | 0 | 0 | 24.3 | 41.2 | 169.5 |
| Example 1 | | | | | | |
| Comparative | 100 | 0 | 0.25 | 24 | 39.2 | 163.3 |
| Example 2 | | | | | | |
| Comparative | 100 | 0 | 0.5 | 23.5 | 36.3 | 154.5 |
| Example 3 | | | | | | |
| Comparative | 100 | 0 | 1.0 | 23.8 | 37.8 | 158.8 |
| Example 4 | | | | | | |
| Comparative | 95 | 5 | 0 | 22.5 | 36.9 | 164 |
| Example 5 | | | | | | |
| Comparative | 97.5 | 2.5 | 0 | 23.8 | 38.1 | 160.1 |
| Example 6 | | | | | | |
| Comparative | 92.5 | 7.5 | 0.5 | 21.4 | 40.1 | 187.4 |
| Example 7 | | | | | | |
| Example 1 | 95 | 5 | 0.25 | 22.2 | 33.1 | 149.1 |
| Example 2 | 95 | 5 | 0.5 | 21.8 | 29.4 | 134.9 |
| Example 3 | 95 | 5 | 1.0 | 22.1 | 32.5 | 147.1 |
| Example 4 | 95 | 5 | 1.25 | 22.9 | 36.8 | 160.7 |
| Example 5 | 97.5 | 2.5 | 0.25 | 23.5 | 33.1 | 140.9 |
| Example 6 | 97.5 | 2.5 | 0.5 | 22.8 | 31.2 | 136.8 |
| Example 7 | 97.5 | 2.5 | 1.0 | 23.2 | 35.2 | 151.7 |
| Example 8 | 97.5 | 2.5 | 1.25 | 23.9 | 37.2 | 155.6 |

Referring to Table 1, Comparative Examples 1 to 4, in which (each of which) the carbon-based negative electrode active material alone was applied to the negative electrodes without applying a silicon-based negative electrode active material, exhibit high initial resistance and a high resistance increase rate at the high-temperature storage when the compound represented by Chemical Formula 1 was applied to the electrolyte solution.

In each of Comparative Example 5 and Examples 1 to 4, 5 wt % of the silicon-based negative electrode active material was applied to the negative electrode. Compared with Comparative Example 5 exhibiting a resistance increase rate of 164% at the high-temperature storage, Examples 1 to 4 each exhibit a reduced resistance increase rate. For example, each of Examples 1 to 3, in which the compound represented by Chemical Formula 1 was applied in an amount of 0.25 parts by weight to 1.0 part by weight, exhibit a significantly reduced resistance increase rate.

In each of Comparative Example 6 and Examples 5 to 8, the silicon-based negative electrode active material was utilized in an amount of 2.5 wt % to the negative electrode. Compared with Comparative Example 6 exhibiting a resistance increase rate of 160.1% at the high-temperature storage, Examples 5 to 8 each exhibit a much reduced resistance increase rate. For example, Examples 5 and 6, in which (each of which) a content (e.g., amount) of the compound represented by Chemical Formula 1 was 0.25 parts by weight to 0.5 parts by weight, exhibit a significantly reduced resistance increase rate.

Comparative Example 7, in which 7.5 wt % of the silicon-based negative electrode active material was utilized to the negative electrode, exhibits a very high resistance increase rate after the high-temperature storage, even though the compound represented by Chemical Formula 1-1 was applied in an amount of 0.5 parts by weight to the electrolyte solution. Accordingly, while a silicon-based negative electrode active material is applied in an amount of 0.1 wt % to 5 wt % to a negative electrode, when the compound represented by Chemical Formula 1 is concurrently (e.g., simultaneously) applied in a set or predetermined amount to an electrolyte solution, effects of reducing initial resistance in a high-capacity high-voltage battery system and reducing a resistance increase rate at the high-temperature storage are maximized or enhanced. These effects lead to suppressing degradation of a cycle-life (and/or life-cycle) even in situations of rapid charging, high voltage, and/or the like in the high-capacity battery system.

As utilized herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the present disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the appended claims and equivalents thereof.

Reference Numerals

| | |
|---|---|
| 100: rechargeable lithium battery | 112: negative electrode |
| 113: separator | 114: positive electrode |
| 120: battery case | 140: sealing member |

What is claimed is:

1. A rechargeable lithium battery, comprising
a positive electrode comprising a positive electrode active material comprising a lithium cobalt-based oxide;
a negative electrode comprising a negative electrode active material comprising a carbon-based negative electrode active material and a silicon-based negative electrode active material;
a separator between the positive electrode and the negative electrode; and
an electrolyte solution,
wherein the silicon-based negative electrode active material is in an amount of about 0.1 wt % to about 10 wt % based on the total amount of the carbon-based negative electrode active material and the silicon-based negative electrode active material, and
the electrolyte solution comprises a non-aqueous organic solvent, a lithium salt, and an additive, wherein the additive comprises a first compound that is a compound represented by Chemical Formula 1, CsPF₆, or a combination thereof: 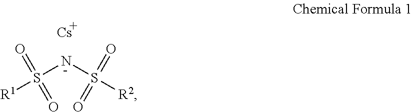
and
wherein, in Chemical Formula 1, R¹ and R² are each independently a fluoro group, or a C1 to C4 fluoroalkyl group substituted with at least one fluoro group.

2. The rechargeable lithium battery of claim 1, wherein
the compound represented by Chemical Formula 1 is represented by Chemical Formula 1-1 or Chemical Formula 1-2:

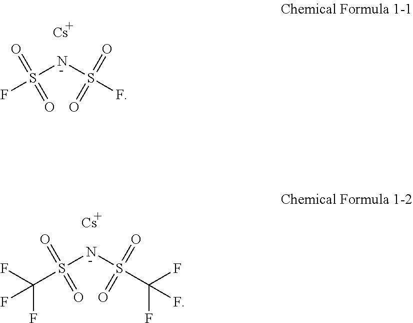

3. The rechargeable lithium battery of claim 1, wherein
the first compound is in an amount of about 0.01 parts by weight to about 5.0 parts by weight based on 100 parts by weight of the total amount of the non-aqueous organic solvent and the lithium salt.

4. The rechargeable lithium battery of claim 1, wherein
the first compound is in an amount of about 0.1 parts by weight to about 1.0 part by weight based on 100 parts by weight of the total amount of the non-aqueous organic solvent and the lithium salt.

5. The rechargeable lithium battery of claim 1, wherein
the first compound is in an amount of about 0.1 parts by weight to about 0.7 parts by weight based on 100 parts by weight of the total amount of the non-aqueous organic solvent and the lithium salt.

6. The rechargeable lithium battery of claim 1, wherein
the additive further comprises a second compound represented by Chemical Formula 2: 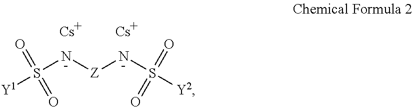
wherein, in Chemical Formula 2,
Z is C(═O) or S(═O)₂, and
Y¹ and Y² are each independently a fluoro group or a C1 to C5 fluoroalkyl group substituted with at least one fluoro group.

7. The rechargeable lithium battery of claim 6, wherein
the second compound represented by Chemical Formula 2 is represented by any one selected from among Chemical Formulas 2-1 to 2-8: 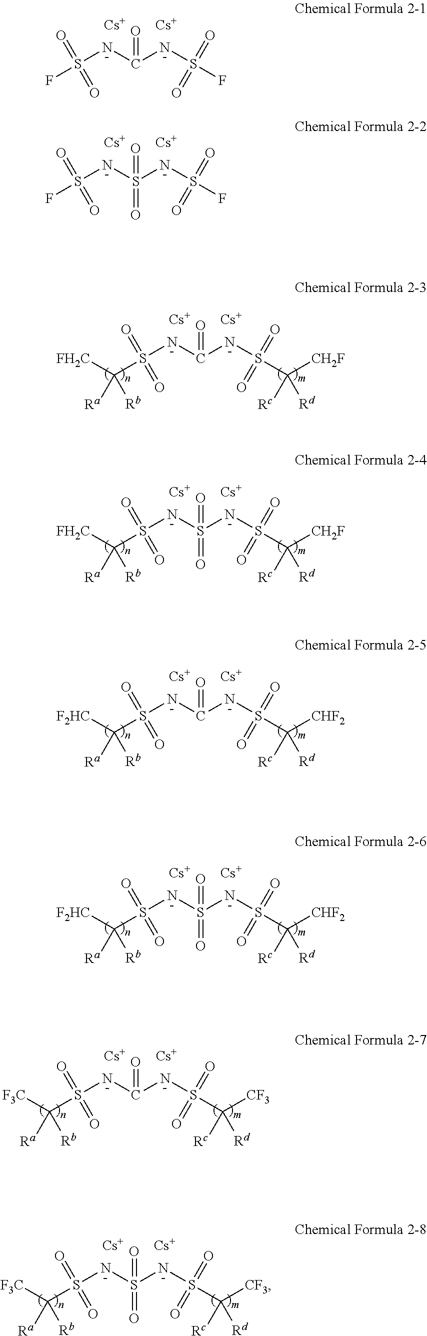
and
wherein, in Chemical Formulas 2-3 to 2-8, Ra, R^{b}, R^{C}, and R^{d} are each independently hydrogen or a fluoro group, and n and m are each independently an integer of 0 to 4.

8. The rechargeable lithium battery of claim 6, wherein
the second compound represented by Chemical Formula 2 is in an amount of about 0.01 parts by weight to about 5 parts by weight based on 100 parts by weight of the total amount of the non-aqueous organic solvent and the lithium salt.

9. The rechargeable lithium battery of claim 1, wherein
the electrolyte solution further comprises one or more other additives, and
the one or more other additives comprise vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluoro biphenyl (2-FBP), or a combination thereof.

10. The rechargeable lithium battery of claim 1, wherein
the non-aqueous organic solvent comprises a carbonate-based solvent and an ester-based solvent.

11. The rechargeable lithium battery of claim 1, wherein
the lithium cobalt-based oxide is represented by Chemical Formula 3: 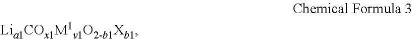
wherein, in Chemical Formula 3,
0.9≤a1≤1.8, 0.7≤x1≤1, 0≤y1≤0.3, 0.9≤x1+y1≤1.1, 0≤b1≤0.1, M¹ is at least one element selected from Al, B, Ba, Ca, Ce, Cr, Cu, Fe, Mg, Mn, Mo, Ni, Se, Si, Sn, Sr, Ti, V, W, Y, Zn and Zr, and X is at least one element selected from F, P, and S.

12. The rechargeable lithium battery of claim 1, wherein
the positive electrode active material comprises
a first positive electrode active material comprising the lithium cobalt-based oxide in a particle form having an average particle diameter (D50) of about 9 μm to about 25 μm, and
a second positive electrode active material comprising the lithium cobalt-based oxide in a particle form having an average particle diameter (D50) of about 1 μm to about 8 μm.

13. The rechargeable lithium battery of claim 12, wherein
the first positive electrode active material is in an amount of about 60 wt % to about 90 wt %, and the second positive electrode active material is in an amount of about 10 wt % to about 40 wt %, based on the total amount of first positive electrode active material and the second positive electrode active material.

14. The rechargeable lithium battery of claim 1, wherein
the silicon-based negative electrode active material is in an amount of about 2 wt % to about 5 wt % based on the total amount of the carbon-based negative electrode active material and the silicon-based negative electrode active material.

15. The rechargeable lithium battery of claim 1, wherein
the silicon-based negative electrode active material comprises silicon-carbon composite particles.

16. The rechargeable lithium battery of claim 15, wherein
an average particle diameter (D50) of the silicon-carbon composite particles is about 0.5 μm to about 20 μm.

17. The rechargeable lithium battery of claim 15, wherein
the silicon-carbon composite particles each comprise a core comprising silicon particles and a carbon coating layer on a surface of the core.

18. The rechargeable lithium battery of claim 17, wherein
the core further comprises crystalline carbon, and the carbon coating layer on the surface of the core comprises amorphous carbon.

19. The rechargeable lithium battery of claim 17, wherein
an average particle diameter (D50) of the silicon particles is about 10 nm to about 200 nm.

20. The rechargeable lithium battery of claim 17, wherein
the core comprises a void in a central portion of a corresponding silicon-carbon composite particle of the silicon-carbon composite particles, and a radius of the void is about 30 length % to about 50 length % of a radius of the corresponding silicon-carbon composite particle.
